(19) United States
(12) Patent Application Publication
(10) Pub. No.: US 2006/0231123 A1
(43) Pub. Date: Oct. 19, 2006

(54) Method for removing a layer area of a component

(76) Inventors: Nigel-Philip Cox, Mulheim (DE); Uta Maier, Schwerin (DE); Michael Ott, Mülheim an der Ruhr (DE); Ralph Reiche, Berlin (DE); Ronald Zimmer, Obermichelbach (DE)

Correspondence Address: Siemens Corporation;Intellectual Property Department, 170 Wood Avenue South, Iselin, NJ, 08830, US

(21) Appl. No.: 10/531,219

(22) PCT Filed: Aug. 20, 2003
(86) PCT No.: PCT/EP03/09235

§ 371 Date: Apr. 5, 2006

(30) Foreign Application Priority Data
Oct. 18, 2002 (EP) 02023394.6

(51) Int. Cl. B08B 3/12; B08B 3/00

(52) U.S. Cl. 134/26; 134/28; 134/1

(57) ABSTRACT

Prior art methods for removing a layer area of a component (stripping) lead to poor results since a removal, for example, ensues in a nonuniform manner. In addition, these prior art methods are time intensive. An inventive method for removing a layer area of a component consists of firstly treating the layer areas to be removed with a salt solution and then with acid, whereby in an intermediate or final step, the component is treated with a complexing agent.

The invention relates to a method for removing a layer area of a component.

In modern energy generation plants, such as for example gas turbine installations, efficiency plays an important role, since it is a parameter which can be used to reduce the costs of operation of the gas turbine installation.

The possible way of increasing the efficiency and thereby reducing the operating costs is to increase inlet temperatures of a combustion gas within a gas turbine.

For this reason, ceramic thermal barrier coatings have been developed and are applied to components that are subject to thermal loading, for example made from super alloys, which are no longer able to withstand even the high inlet temperatures over the course of time.

The ceramic thermal barrier coating offers the advantage of a high thermal stability on account of its ceramic properties, and the metallic substrate offers the advantage of good mechanical properties in this assembly or layer system. A bonding layer of composition MCrAlY (main constituents), in which M means that a metal selected from the group consisting of nickel, chromium or iron is used, is typically applied between the substrate in the ceramic thermal barrier coating.

The composition of these MCrAlY layers may vary, but despite the ceramic layer on top of them, all MCrAlY layers are subject to corrosion as a result of oxidation, sulfidation or other chemical and/or mechanical attacks.

It is often the case that the MCrAlY layer is degraded to a greater extent than the metallic substrate (for example Ni, Co-based super alloy), i.e. the service life of the composite system comprising substrate and layer is determined by the service life of the MCrAlY layer.

After prolonged use, the MCrAlY layer has only a limited ability to function, whereas the substrate may still be fully functional.

Therefore, there is a need for the components which have been degraded in use, for example turbine rotor blades or guide vanes or combustion chamber parts, to be reworked, during which process the corroded layers or zones of the MCrAlY layer or of the substrate have to be removed in order if appropriate for new MCrAlY layers or other protective layers and/or again a thermal barrier coating to be applied. The use of existing, used substrate reduces the costs of operation of gas turbine installations.

In this context, it must be ensured that the design of the turbine blades and guide vanes is not altered, i.e. that there is a uniform removal of material from the surface. Furthermore, there should be no residues of corrosion products, which represent a defect source during new coating with a MCrAlY layer and/or another protective layer and/or a ceramic thermal barrier coating or would lead to poor bonding of these layers.

EP 759 098 B1 shows a method for cleaning turbine blade in which potassium hydroxide is used.

It is also part of the prior art for corroded layers to be removed by acid stripping, as is known from U.S. Pat. No. 5,944,909.

The known methods often do not actually remove any material or remove material unevenly, and are also very time-consuming.

Therefore, it is an object of the invention to overcome this problem.

The object is achieved by a method as claimed in claim 1, in which the component is treated in a salt bath prior to an acid treatment.

Further advantageous method steps are listed in the subclaims.

In the drawing:

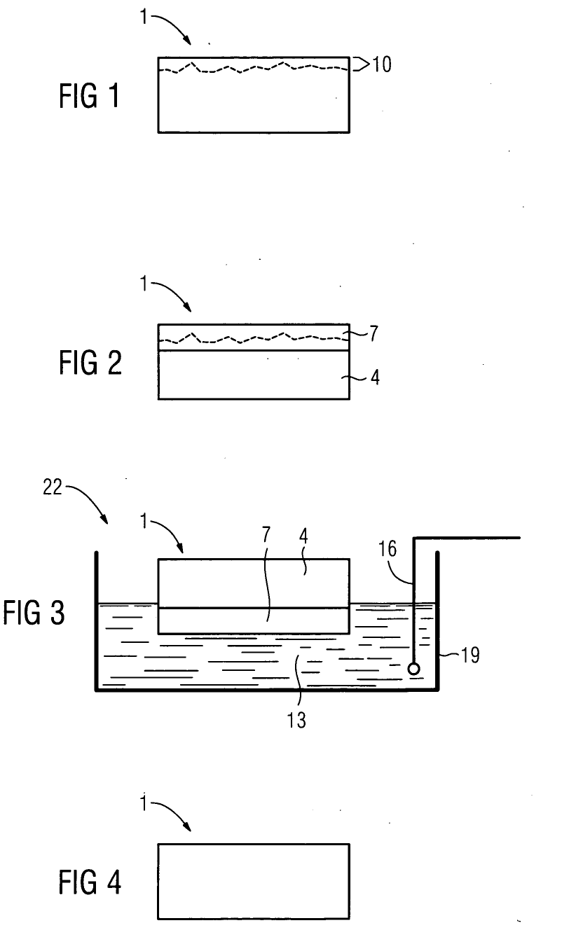

FIG. 1 shows a component,

FIG. 2 shows a layer system,

FIG. 3 shows an apparatus for carrying out the method according to the invention, and

FIG. 4 shows a component that has been treated with the method according to the invention.

FIG. 1 shows a component 1 which is to be treated using the method according to the invention.

The component 1, which consists, for example, of metal or a metal alloy, has a surface region 10 which has been degraded, for example through corrosion, oxidation or in some other way, and needs to be removed. The surface region 10 consists, for example, of an oxide which has formed at high temperatures.

Regions which have not degraded can also be removed by the method according to the invention.

FIG. 2 shows a further component 1 which can be treated by the method according to the invention.

The component 1 comprises a substrate 4 (e.g. nickel-based, cobalt-based super alloy) and a layer 7 (e.g. MCrAlY) which has degraded and needs to be removed by the method according to the invention.

The substrate 4 may also have degraded, in which case the degraded regions of the substrate 4 can likewise be removed, for example.

By way of example, in a first method step initial abrasion of the layer regions 7, 10 to be removed and/or of a ceramic thermal barrier coating arranged above the layer 7 can be realized by coarse preliminary mechanical cleaning measures, such as for example sand blasting or flow grinding.

The treatment by sand blasting and/or flow grinding can also take place between or after the individual salt and acid treatments or at the end.

This is followed by a treatment of the component 1, in particular of the layer areas 7, 10 to be removed, in a liquid salt bath (molten salt), in which at least the areas 7, 10 of the component 1 are immersed.

The term salts is to be understood as meaning inter alia, by way of example, compounds of metal (metal ion) and acid residue (acid less 1 hydrogen ion), i.e. for example NaHCO₃, Na₂CO₃, CaCO₃, . . . and/or base residue.

The use of a compound of this type for the salt bath presupposes that the salt chemically attacks the component 1.

It is also possible for the entire component 1, if appropriate after it has been masked, to be immersed in the salt bath.

The salt bath consists, for example, of sodium hydroxide (NaOH) or potassium hydroxide (KOH) (i.e. for example a molten salt bath, that is to say in liquid form at higher temperatures than room temperature). It is also possible for the two salts to be used together, in which case they in particular have a mixing ratio of 50 to 50% by volume.

Further salt baths are conceivable.

By way of example, it is also possible for sodium oxide (NaO₂) to be added to the above salts as an oxygen donor, so as to boost the chemical attack on the areas to be removed. Further oxygen donors are conceivable, such as for example a supply of oxygen, oxides or metal oxides.

Treatments on the component 1 can also be carried out in various salt baths in succession.

By way of example after one, for example after each, treatment in the salt bath, watering and/or drying is carried out. In this case, by way of example, the temperature differences between salt bath and the watering medium are used for a thermal shock which mechanically weakens the layer area to be removed by forming cracks.

The at least one salt bath treatment is followed by an acid treatment in at least a first acid bath, which consists of an acid or a mixture of acids.

In a first step, an acid treatment is carried out using, for example, nitric acid HNO₃ and/or phosphoric acid H₃PO₄.

Further acids (e.g. sulfuric acid, sulfurous acid, nitrous acid, carbonic acid, hydrofluoric acid, etc.) and/or acid mixtures are conceivable and are matched to the particular salt bath.

After possible further watering and drying, by way of example, at least one further treatment is carried out using hydrochloric acid HCl as second acid bath.

Other acids are conceivable for the optional second acid bath, but they differ from the acids of the first acid bath.

For example after one, for example each, treatment with acid, watering and/or drying is carried out.

The individual treatment steps, in which the component comes into contact with the salt bath or the various acids, as well as the watering and drying can in each case be repeated a number of times.

FIG. 3 shows an apparatus 22, with which the method according to the invention can be carried out.

The apparatus 22 comprises a vessel 19 in which there is a liquid salt or salt mixture or an acid.

The component 1 is immersed in this liquid.

The method can be shortened and/or improved if an ultrasound probe 16 is present and operated in the bath 13.

FIG. 4 shows a component 1 which has been treated using the method according to the invention.

The component 1 no longer has any corroded areas.

The following text lists examples of treatment sequences:
1. Flow grinding
2. Salt bath or mixed salt bath for 1.0 hour,
3. Phosphoric acid bath for 1.0 hour,
4. Sand blasting
5. Hydrochloric acid bath for 1.5 hours,
6. Watering and/or drying,
7. Hydrochloric acid bath for 1.5 hours,
8. Ultrasound cleaning with complex-forming agent
1. Sand blasting
2. Salt bath for 1.0 hour,
3. Phosphoric acid bath for 1.0 hour,
4. Flow grinding,
5. Hydrochloric acid bath for 2.0 hours,
6. Watering and/or drying,
7. Hydrochloric acid bath for 2.0 hours,
8. Ultrasound cleaning with complex-forming agent
1. Sand blasting
2. Salt bath for 1.0 hour,
3. Phosphoric acid bath for 1.0 hour,
4. Flow grinding,
5. Ultrasound cleaning with complex-forming agent
6. Hydrochloric acid bath for 2.0 hours,
9. Watering and/or drying,
7. Hydrochloric acid bath for 2.0 hours
1. Salt bath for 1.0 hour,
2. Phosphoric acid bath for 1.0 hour,
1. Salt bath
2. Phosphoric acid bath
3. Watering
4. Phosphoric acid bath
1. Sand blasting
2. Salt bath for 1.0 hour,
3. Phosphoric/nitric acid bath for 1.0 hour
1. Sand blasting
2. Salt bath for 1.0 hour,
3. Phosphoric/nitric acid bath for 1.0 hour
4. Hydrochloric acid bath
1. Sand blasting
2. Salt bath for 1.0 hour,
3. Phosphoric acid bath for 1.0 hour
4. Hydrochloric acid bath
1. Sand blasting
2. Salt bath for 1.0 hour,
3. Nitric acid bath for 1.0 hour
4. Hydrochloric acid bath

The flow grinding (cf. for a description DE 199 02 422 A1) is particularly suitable for components 1, in particular for blades and vanes of turbines, with interior spacers wherein there are degraded areas in the interior space.

Outer areas are preferably sand-blasted, with corundum, for example, being used for this purpose.

In particular the maximum blasting pressure and the particle size of the blasting medium have to be set in order not to damage the substrate.

For the salt bath it is preferable to use a salt produced by Degussa marketed under the trade name DUFERRIT RS DGS.

Oxides of the component which are exposed to the salt bath are transformed into oxide-richer compounds, which are more acid-soluble.

The expansion coefficients of oxides and metals generally differ. Transferring the components 1 from a warm salt bath to a quenching water bath causes a thermal shock which produces cracks in the area (7, 11) to be removed and mechanically weakens the latter, for example by increasing the surface areas available for the salt and/or acid to attack.

This thermal shock is used as an additional effect during the cleaning.

During the quenching treatment, it should be ensured that a stipulated temperature gradient in the component is not exceeded, so that no cracks are produced in the substrate or component.

The complex-forming agent used is diammonium EDTA. The complex-forming agent can bind metals, allowing them to be removed. The treatment with the complex-forming agent can take place between, before or after the individual salt and acid treatments.

In this case too, an ultrasound probe 16 can once again be used in the bath 13 containing the complex-forming agent in order to accelerate the method.

1-12. (canceled)

13. A method for removing a layer area of a turbine component, comprising:
treating the turbine component in a salt bath comprising sodium hydroxide and potassium hydroxide;
treating the turbine component with a first acid comprising nitric acid and phosphoric acid; and
adding an oxygen donor to the salt bath.

14. The method as claimed in claim 13, wherein potassium hydroxide and sodium hydroxide in a mixture ratio of 1 to 1% by volume is used for the salt bath.

15. The method as claimed in claim 13, wherein two different acid baths are used.

16. The method as claimed in claim 13, wherein hydrochloric acid is used as acid for a second acid bath.

17. The method as claimed in claim 16, wherein nitric acid and phosphoric acid and then hydrochloric acid is used.

18. The method as claimed in claim 13, wherein an ultrasound probe is used in the bath to accelerate the method.

19. The method as claimed in claim 13, wherein that before the treatment of the turbine component in the salt bath and/or after the treatment in the salt bath and/or after the first acid treatment and/or after a further acid treatment, the turbine component having a layer area that is to be removed is sand-blasted.

20. The method as claimed in claim 13, wherein that before the treatment of the turbine component in the salt bath and/or after the treatment in the salt bath and/or after the first acid treatment and/or after a further acid treatment, the flow grinding of the turbine component having a layer area that is to be removed is performed.

21. The method as claimed in claim 13, wherein at least one oxygen donor is added to the salt bath.

22. The method as claimed in claim 21, wherein the oxygen donor is sodium oxide.

23. The method as claimed in claim 21, wherein the oxygen donor is a metal oxide.

24. The method as claimed in claim 13, wherein the turbine component is watered and dried in at least one intermediate step.

25. The method as claimed in claim 13, wherein the turbine component is watered or dried in at least one intermediate step.

26. The method as claimed in claim 13, wherein the turbine component is treated with a complex-forming agent in an intermediate or final step.
